(19) United States
(12) Patent Application Publication
(10) Pub. No.: US 2020/0134708 A1
(43) Pub. Date: Apr. 30, 2020

(54) PLATFORM FOR PRIVATE AND PUBLIC COMMUNICATION

(71) Applicant: Matthew Scott Bertram, Atlanta, GA (US)

(72) Inventor: Matthew Scott Bertram, Atlanta, GA (US)

(21) Appl. No.: 16/173,399

(22) Filed: Oct. 29, 2018

(51) Int. Cl. G06Q 30/08; H04L 12/58; H04W 4/12

(52) U.S. Cl. CPC G06Q 30/08; H04W 4/12; H04L 51/16; H04L 51/06

(57) ABSTRACT

Systems and methods for converting private communications to public communications are described. The systems and methods may facilitate conveying a first message of a conversation from a bidding user to a controlling user, wherein the first message is sent according to a private mode of communication, prompting the controlling user to select between the private mode and a public mode after conveying the first message, receiving an indication from the controlling user to select a public mode based on the prompting, and conveying the conversation, including the first message, to a plurality of additional bidding users based on the indication from the controlling user.

### BACKGROUND

The following relates generally to digital communication, and more specifically to converting private communications to public communications.

Many communication platforms have both public and private communication areas. For example, a communication platform may have a public wall or homepage where users can share with the entire community. The platform may also have a private inbox or messaging feature that allows for users to share private communications. However, in many cases private communications may be relevant to a larger audience, and transferring private communications to a separate public forum may be time consuming and inconvenient.

### SUMMARY

A method for converting private communications to public communications is described. The method may include conveying a first message of a conversation from a bidding user to a controlling user, wherein the first message is sent according to a private mode of communication, prompting the controlling user to select between the private mode and a public mode after conveying the first message, receiving an indication from the controlling user to select a public mode based on the prompting, and conveying the conversation, including the first message, to a plurality of additional bidding users based on the indication from the controlling user.

A system for digital communication is described. The system may include a processor, memory in electronic communication with the processor, and instructions stored in the memory. The instructions may be operable to cause the processor to convey a first message of a conversation from a bidding user to a controlling user, wherein the first message is sent according to a private mode of communication, prompt the controlling user to select between the private mode and a public mode after conveying the first message, receive an indication from the controlling user to select a public mode based on the prompting, and convey the conversation, including the first message, to a plurality of additional bidding users based on the indication from the controlling user.

A non-transitory computer readable medium storing code for digital communication is described. In some examples, the code comprises instructions executable by a processor to: convey a first message of a conversation from a bidding user to a controlling user, wherein the first message is sent according to a private mode of communication, prompt the controlling user to select between the private mode and a public mode after conveying the first message, receive an indication from the controlling user to select a public mode based on the prompting, and convey the conversation, including the first message, to a plurality of additional bidding users based on the indication from the controlling user.

An apparatus for converting private communications to public communications is described. The apparatus may include means for conveying a first message of a conversation from a bidding user to a controlling user, wherein the first message is sent according to a private mode of communication, means for prompting the controlling user to select between the private mode and a public mode after conveying the first message, means for receiving an indication from the controlling user to select a public mode based on the prompting, and means for conveying the conversation, including the first message, to a plurality of additional bidding users based on the indication from the controlling user.

Some examples of the method, system, non-transitory computer-readable medium, and apparatus described above may further include conveying a second message of the conversation from the controlling user to the bidding user and the plurality of additional bidding users based on the indication that the controlling user has selected the public mode.

Some examples of the method, system, non-transitory computer-readable medium, and apparatus described above may further include receiving an authorization from the bidding user that the controlling user is allowed to select the public mode, wherein prompting the controlling user is based on the authorization from the bidding user.

Some examples of the method, system, non-transitory computer-readable medium, and apparatus described above may further include receiving a subsequent indication from the controlling user to select a private mode for a subsequent conversation. Some examples of the method, system, non-transitory computer-readable medium, and apparatus described above may further include preventing the plurality of additional bidding users from accessing the subsequent conversation based on the subsequent indication.

Some examples of the method, system, non-transitory computer-readable medium, and apparatus described above may further include conveying at least one subsequent message of the conversation to the plurality of additional bidding users based on the indication from the controlling user.

Some examples of the method, system, non-transitory computer-readable medium, and apparatus described above may further include setting the public mode as a default mode based on the indication. Some examples of the method, system, non-transitory computer-readable medium, and apparatus described above may further include conveying at least one subsequent message of the conversation to the plurality of additional bidding users based on the public mode.

Some examples of the method, system, non-transitory computer-readable medium, and apparatus described above may further include receiving a request from the controlling user to merge the additional message into the conversation. Some examples of the method, system, non-transitory computer-readable medium, and apparatus described above may further include merging the at least one additional message into the conversation based on the request.

In some examples of the method, system, non-transitory computer-readable medium, and apparatus described above, the bidding user and the plurality of additional bidding users represent financial institutions, and the first message comprises a question related to financial information available to the controlling user.

In some examples of the method, system, non-transitory computer-readable medium, and apparatus described above, the first message is conveyed to the controlling user by posting the first message to a private inbox of the controlling user. In some examples of the method, system, non-transitory computer-readable medium, and apparatus described above, the conversation is conveyed to the plurality of additional users by automatically posting the conversation to a public message board in response to receiving the indication from the controlling user.

Some examples of the method, system, non-transitory computer-readable medium, and apparatus described above may further include notifying the bidding user that the controlling user may select the public mode prior to conveying the first message to the controlling user.

Some examples of the method, system, non-transitory computer-readable medium, and apparatus described above may further include receiving a subsequent indication from the controlling user to select a private mode. Some examples of the method, system, non-transitory computer-readable medium, and apparatus described above may further include restricting access to the conversation for the plurality of additional bidding users based on the subsequent indication.

Some examples of the method, system, non-transitory computer-readable medium, and apparatus described above may further include receiving one or more edits from the controlling user. Some examples of the method, system, non-transitory computer-readable medium, and apparatus described above may further include modifying the conversation based on the one or more edits, wherein conveying the conversation to the plurality of additional bidding users comprises conveying the modified conversation.

Some examples of the method, system, non-transitory computer-readable medium, and apparatus described above may further include conveying a subsequent message of the conversation according to the private mode, wherein the private mode comprises a default mode for each message of the conversation. Some examples of the method, system, non-transitory computer-readable medium, and apparatus described above may further include prompting the controlling user to select between the private mode and the public mode for the subsequent message.

### BRIEF DESCRIPTION OF THE DRAWINGS

FIG. 1 shows an example of a system for digital communication in accordance with aspects of the present disclosure.

FIG. 2 shows an example of a communication server in accordance with aspects of the present disclosure.

FIGS. 3 through 9 show examples of processes for digital communication in accordance with aspects of the present disclosure.

### DETAILED DESCRIPTION

The present disclosure describes a method of transforming a private communication into a public communication. According to one embodiment, a user may send a message using a private mode. The receiver of the message may then indicate that the communication should be public, and the message may be automatically transferred to a public mode, or to a public forum.

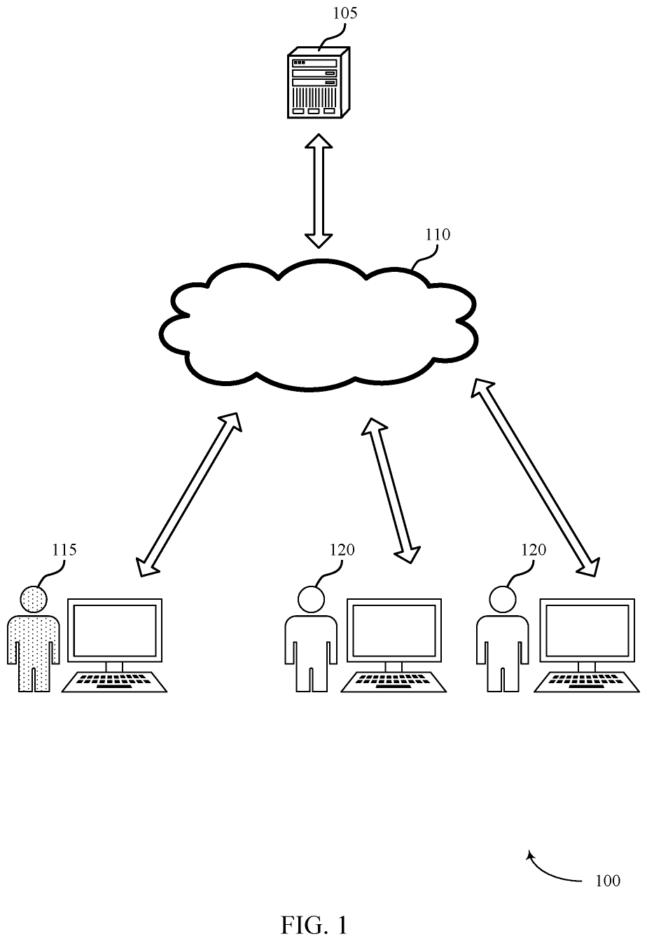

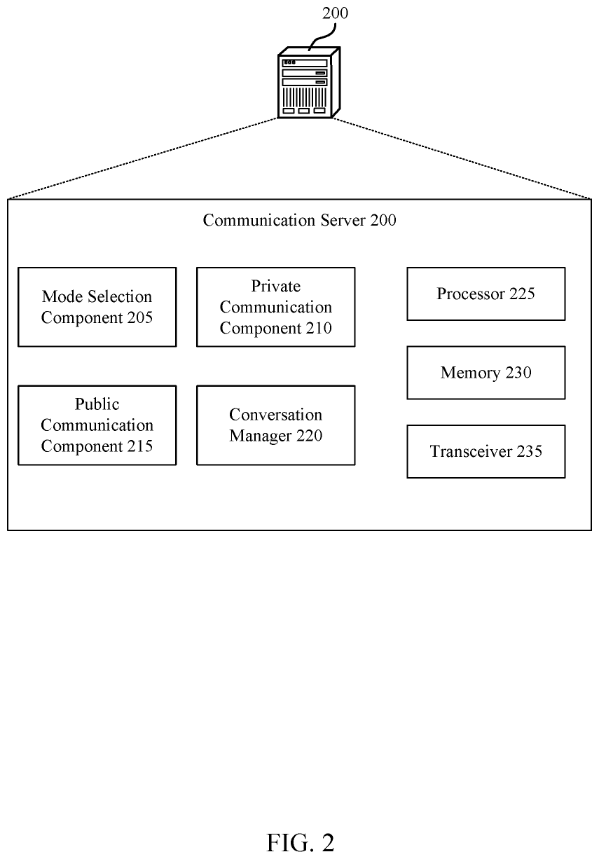

FIG. 1 shows an example of a system for digital communication in accordance with aspects of the present disclosure. Communication system 100 may include communication server 105, network 110, controlling user 115, and bidding user(s) 120. Communication server 105 may be an example of, or include aspects of, the corresponding element described with reference to FIG. 2.

The user that determines whether the communication is public or private may be referred to as the controlling user 115. In some cases, the user that does not control whether the communication is public or private may be known as the bidding user 120. For example, a bidding user 120 may be one of several users that are requesting information from the controlling user 115. Bidding users 120 may communicate messages through the communication server 105 (and via network 110) to the controlling user 115. In some cases, the user sending the original message does not have the ability to determine whether the message and the on-going messaging chain will be public or private. That is, the original messenger may send a message knowing that the original message (and, in some cases, any ongoing responses) may be made public by the receiver.

One application of the disclosed methods may include a marketplace where multiple users are bidding on an asset (or service) based on information provided by the seller (i.e., the controlling user 115). The seller may have a desire to make some communications public and to keep some communications private. For example, making a communication public may enable the user to more efficiently provide information that is relevant to more than one bidding user 120. However, some information may only be relevant to a single bidder.

For example, many of the bidding users 120 may have the same or similar questions. Rather than answering all of these similar questions individually through private communications, the present disclosure describes methods that allow the controlling user 115 to determine what they consider private or proprietary and respond to those questions privately. The disclosed methods also allows the controlling user 115 to determine whether certain communications are public and post those communications publicly for all users to see.

In some embodiments, a bidding user 120 may communicate a message privately in a manner that does not enable the controlling user 115 to select a public mode for the communication. In some embodiments, a system implementing aspects of the present disclosure may provide notice to the bidding users 120 that their communications may be made public.

The methods of the present disclosure may be implemented in any communication platform where many users may have the same questions or similar types of communications. The controlling user 115 may then decide whether to consider the answer to a question proprietary (or, in some cases, the mere fact that a question was asked may be proprietary).

Examples of platforms where the disclosed systems and methods may be implemented include financial marketplaces, Frequently Asked Questions databases, inter-company communication solutions, social media platforms. In some cases, a communications platform implementing aspects of the present disclosure may be directed to facilitating transactions in a particular industry such as oil and gas, real estate, crowd financing, custom manufacturing, venture capital, private equity, investment banking, mergers and acquisitions, etc.

In some examples, the bidding user 120 and the plurality of additional bidding users 120 represent financial institutions, and the first message comprises a question related to financial information available to the controlling user 115.

FIG. 2 shows an example of a communication server 200 in accordance with aspects of the present disclosure. Communication server 200 may be an example of, or include aspects of, the corresponding elements described with reference to FIG. 1.

Communication server 200 may include mode selection component 205, private communication component 210, public communication component 215, conversation manager 220, processor 225, memory 230, and transceiver 235.

Mode selection component 205 may prompt the controlling user to select between the private mode and a public mode after conveying the first message. Mode selection component 205 may also receive an indication from the controlling user to select a public mode based on the prompting.

In some embodiments, mode selection component 205 may also receive an authorization from the bidding user that the controlling user is allowed to select the public mode, wherein prompting the controlling user is based on the authorization from the bidding user.

Mode selection component 205 may also receive a subsequent indication from the controlling user to select a private mode. Mode selection component 205 may then prompt the controlling user to select between the private mode and the public mode for a subsequent message.

Mode selection component 205 may also receive a subsequent indication from the controlling user to select a private mode for a subsequent conversation. Mode selection component 205 may then set the public mode as a default mode based on the indication. Mode selection component 205 may also notify the bidding user that the controlling user may select the public mode prior to conveying the first message to the controlling user.

Private communication component 210 may convey a first message of a conversation from a bidding user to a controlling user, wherein the first message is sent according to a private mode of communication. In some examples, the first message is conveyed to the controlling user by posting the first message to a private inbox of the controlling user. Private communication component 210 may also convey a subsequent message of the conversation according to the private mode, where the private mode comprises a default mode for each message of the conversation.

Public communication component 215 may convey a conversation, including a first message, to a plurality of bidding users based on an indication from the controlling user. Public communication component 215 may also convey a second message of the conversation from the controlling user to the bidding user and the plurality of additional bidding users based on the indication that the controlling user has selected the public mode.

Public communication component 215 may also prevent the plurality of additional bidding users from accessing the subsequent conversation based on a subsequent indication. Public communication component 215 may also convey at least one subsequent message of the conversation to the plurality of additional bidding users based on the indication from the controlling user.

Public communication component 215 may also convey at least one subsequent message of the conversation to the plurality of additional bidding users based on the public mode. In some examples, the conversation is conveyed to the plurality of additional users by automatically posting the conversation to a public message board in response to receiving the indication from the controlling user.

Public communication component 215 may also restrict access to the conversation for the plurality of additional bidding users based on a subsequent indication.

Conversation manager 220 may receive a request from the controlling user to merge the additional message into the conversation. Conversation manager 220 may then merge the at least one additional message into the conversation based on the request. Conversation manager 220 may also receive one or more edits from the controlling user. Conversation manager 220 may then modify the conversation based on the one or more edits, such that conveying the conversation to the plurality of additional bidding users comprises conveying the modified conversation.

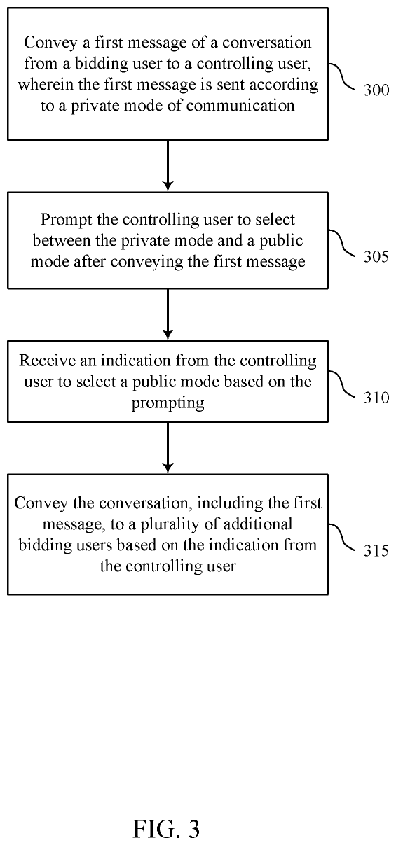

FIG. 3 shows an example of a process for digital communication in accordance with aspects of the present disclosure. In some examples, these operations may be performed by a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 300, a system may convey a first message of a conversation from a bidding user to a controlling user, wherein the first message is sent according to a private mode of communication. In some cases, the operations of this step may refer to, or be performed by, a private communication component as described with reference to FIG. 2.

At step 305, a system may prompt the controlling user to select between the private mode and a public mode after conveying the first message. In some cases, the operations of this step may refer to, or be performed by, a mode selection component as described with reference to FIG. 2.

At step 310, a system may receive an indication from the controlling user to select a public mode based on the prompting. In some cases, the operations of this step may refer to, or be performed by, a mode selection component as described with reference to FIG. 2.

At step 315, a system may convey the conversation, including the first message, to a plurality of additional bidding users based on the indication from the controlling user. In some cases, the operations of this step may refer to, or be performed by, a public communication component as described with reference to FIG. 2.

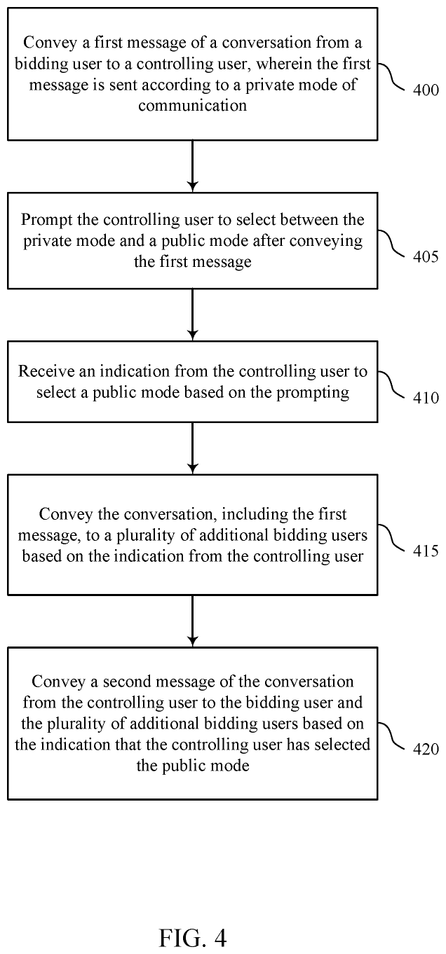

FIG. 4 shows an example of a process for digital communication in accordance with aspects of the present disclosure. In some examples, these operations may be performed by a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 400, a system may convey a first message of a conversation from a bidding user to a controlling user, wherein the first message is sent according to a private mode of communication. In some cases, the operations of this step may refer to, or be performed by, a private communication component as described with reference to FIG. 2.

At step 405, a system may prompt the controlling user to select between the private mode and a public mode after conveying the first message. In some cases, the operations of this step may refer to, or be performed by, a mode selection component as described with reference to FIG. 2.

At step 410, a system may receive an indication from the controlling user to select a public mode based on the prompting. In some cases, the operations of this step may refer to, or be performed by, a mode selection component as described with reference to FIG. 2.

At step 415, a system may convey the conversation, including the first message, to a plurality of additional bidding users based on the indication from the controlling user. In some cases, the operations of this step may refer to, or be performed by, a public communication component as described with reference to FIG. 2.

At step 420, a system may convey a second message of the conversation from the controlling user to the bidding user and the plurality of additional bidding users based on the indication that the controlling user has selected the public mode. In some cases, the operations of this step may refer to, or be performed by, a public communication component as described with reference to FIG. 2.

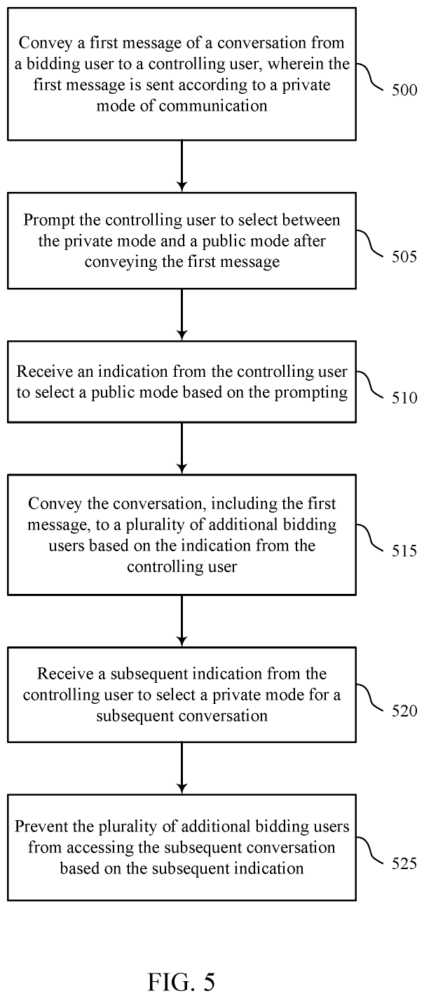

FIG. 5 shows an example of a process for digital communication in accordance with aspects of the present disclosure. In some examples, these operations may be performed by a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 500, a system may convey a first message of a conversation from a bidding user to a controlling user, wherein the first message is sent according to a private mode of communication. In some cases, the operations of this step may refer to, or be performed by, a private communication component as described with reference to FIG. 2.

At step 505, a system may prompt the controlling user to select between the private mode and a public mode after conveying the first message. In some cases, the operations of this step may refer to, or be performed by, a mode selection component as described with reference to FIG. 2.

At step 510, a system may receive an indication from the controlling user to select a public mode based on the prompting. In some cases, the operations of this step may refer to, or be performed by, a mode selection component as described with reference to FIG. 2.

At step 515, a system may convey the conversation, including the first message, to a plurality of additional bidding users based on the indication from the controlling user. In some cases, the operations of this step may refer to, or be performed by, a public communication component as described with reference to FIG. 2.

At step 520, a system may receive a subsequent indication from the controlling user to select a private mode for a subsequent conversation. In some cases, the operations of this step may refer to, or be performed by, a mode selection component as described with reference to FIG. 2.

At step 525, a system may prevent the plurality of additional bidding users from accessing the subsequent conversation based on the subsequent indication. In some cases, the operations of this step may refer to, or be performed by, a public communication component as described with reference to FIG. 2.

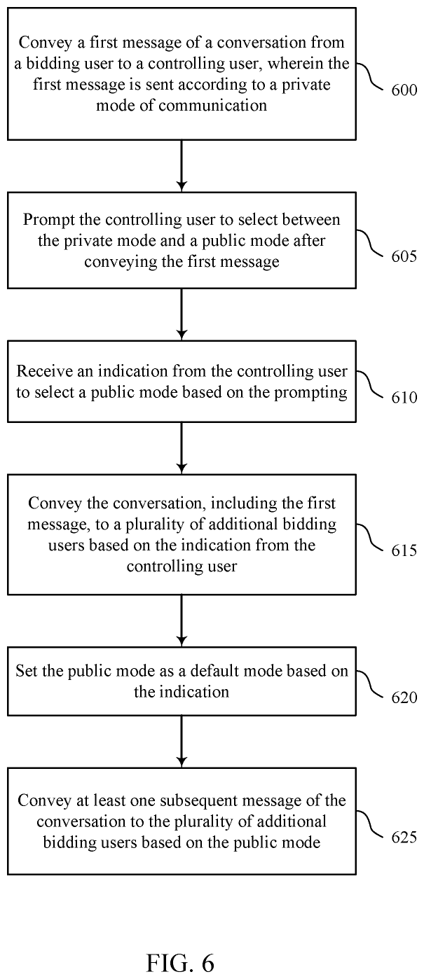

FIG. 6 shows an example of a process for digital communication in accordance with aspects of the present disclosure. In some examples, these operations may be performed by a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 600, a system may convey a first message of a conversation from a bidding user to a controlling user, wherein the first message is sent according to a private mode of communication. In some cases, the operations of this step may refer to, or be performed by, a private communication component as described with reference to FIG. 2.

At step 605, a system may prompt the controlling user to select between the private mode and a public mode after conveying the first message. In some cases, the operations of this step may refer to, or be performed by, a mode selection component as described with reference to FIG. 2.

At step 610, a system may receive an indication from the controlling user to select a public mode based on the prompting. In some cases, the operations of this step may refer to, or be performed by, a mode selection component as described with reference to FIG. 2.

At step 615, a system may convey the conversation, including the first message, to a plurality of additional bidding users based on the indication from the controlling user. In some cases, the operations of this step may refer to, or be performed by, a public communication component as described with reference to FIG. 2.

At step 620, a system may set the public mode as a default mode based on the indication. In some cases, the operations of this step may refer to, or be performed by, a mode selection component as described with reference to FIG. 2.

At step 625, a system may convey at least one subsequent message of the conversation to the plurality of additional bidding users based on the public mode. In some cases, the operations of this step may refer to, or be performed by, a public communication component as described with reference to FIG. 2.

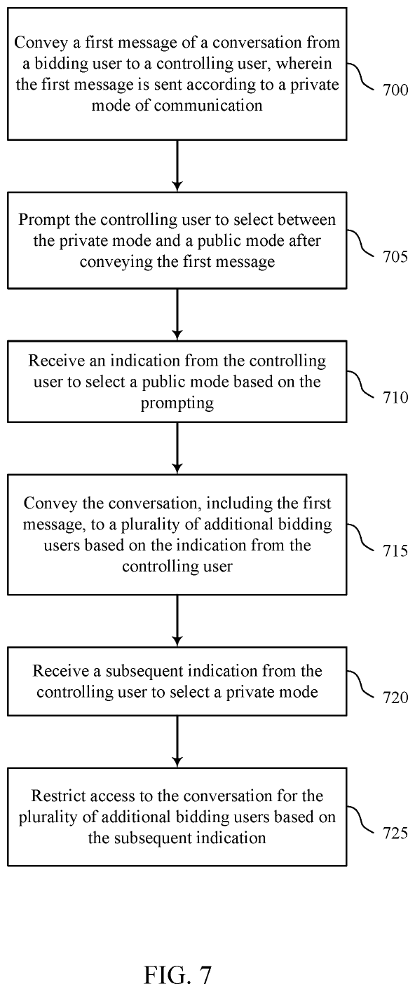

FIG. 7 shows an example of a process for digital communication in accordance with aspects of the present disclosure. In some examples, these operations may be performed by a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 700, a system may convey a first message of a conversation from a bidding user to a controlling user, wherein the first message is sent according to a private mode of communication. In some cases, the operations of this step may refer to, or be performed by, a private communication component as described with reference to FIG. 2.

At step 705, a system may prompt the controlling user to select between the private mode and a public mode after conveying the first message. In some cases, the operations of this step may refer to, or be performed by, a mode selection component as described with reference to FIG. 2.

At step 710, a system may receive an indication from the controlling user to select a public mode based on the prompting. In some cases, the operations of this step may refer to, or be performed by, a mode selection component as described with reference to FIG. 2.

At step 715, a system may convey the conversation, including the first message, to a plurality of additional bidding users based on the indication from the controlling user. In some cases, the operations of this step may refer to, or be performed by, a public communication component as described with reference to FIG. 2.

At step 720, a system may receive a subsequent indication from the controlling user to select a private mode. In some cases, the operations of this step may refer to, or be performed by, a mode selection component as described with reference to FIG. 2.

At step 725, a system may restrict access to the conversation for the plurality of additional bidding users based on the subsequent indication. In some cases, the operations of this step may refer to, or be performed by, a public communication component as described with reference to FIG. 2.

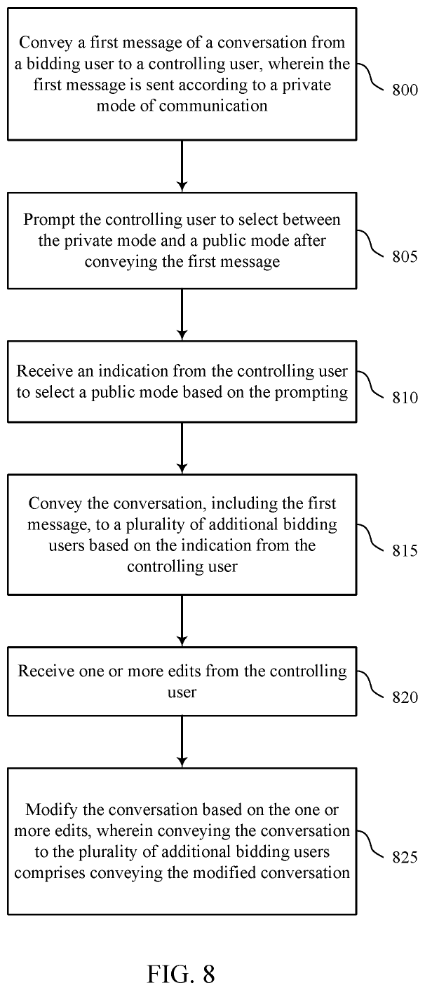

FIG. 8 shows an example of a process for digital communication in accordance with aspects of the present disclosure. In some examples, these operations may be performed by a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 800, a system may convey a first message of a conversation from a bidding user to a controlling user, wherein the first message is sent according to a private mode of communication. In some cases, the operations of this step may refer to, or be performed by, a private communication component as described with reference to FIG. 2.

At step 805, a system may prompt the controlling user to select between the private mode and a public mode after conveying the first message. In some cases, the operations of this step may refer to, or be performed by, a mode selection component as described with reference to FIG. 2.

At step 810, a system may receive an indication from the controlling user to select a public mode based on the prompting. In some cases, the operations of this step may refer to, or be performed by, a mode selection component as described with reference to FIG. 2.

At step 815, a system may convey the conversation, including the first message, to a plurality of additional bidding users based on the indication from the controlling user. In some cases, the operations of this step may refer to, or be performed by, a public communication component as described with reference to FIG. 2.

At step 820, a system may receive one or more edits from the controlling user. In some cases, the operations of this step may refer to, or be performed by, a conversation manager as described with reference to FIG. 2.

At step 825, a system may modify the conversation based on the one or more edits, wherein conveying the conversation to the plurality of additional bidding users comprises conveying the modified conversation. In some cases, the operations of this step may refer to, or be performed by, a conversation manager as described with reference to FIG. 2.

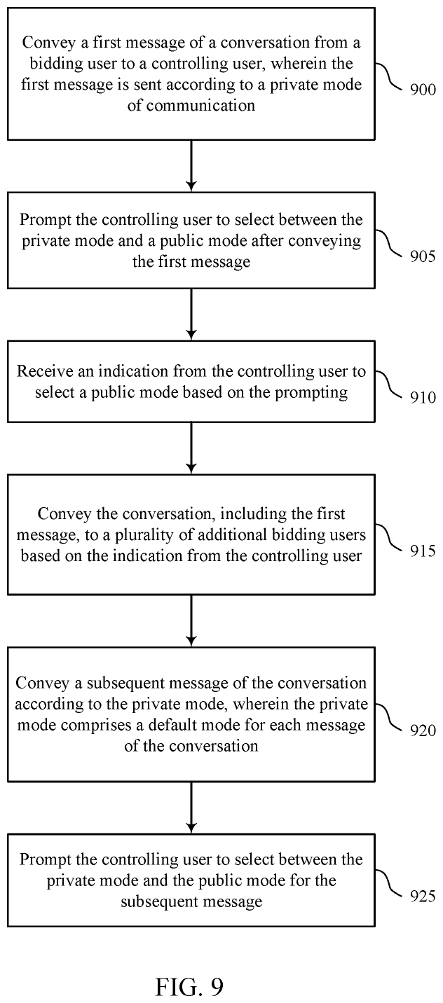

FIG. 9 shows an example of a process for digital communication in accordance with aspects of the present disclosure. In some examples, these operations may be performed by a processor executing a set of codes to control functional elements of an apparatus. Additionally or alternatively, the processes may be performed using special-purpose hardware. Generally, these operations may be performed according to the methods and processes described in accordance with aspects of the present disclosure. For example, the operations may be composed of various substeps, or may be performed in conjunction with other operations described herein.

At step 900, a system may convey a first message of a conversation from a bidding user to a controlling user, wherein the first message is sent according to a private mode of communication. In some cases, the operations of this step may refer to, or be performed by, a private communication component as described with reference to FIG. 2.

At step 905, a system may prompt the controlling user to select between the private mode and a public mode after conveying the first message. In some cases, the operations of this step may refer to, or be performed by, a mode selection component as described with reference to FIG. 2.

At step 910, a system may receive an indication from the controlling user to select a public mode based on the prompting. In some cases, the operations of this step may refer to, or be performed by, a mode selection component as described with reference to FIG. 2.

At step 915, a system may convey the conversation, including the first message, to a plurality of additional bidding users based on the indication from the controlling user. In some cases, the operations of this step may refer to, or be performed by, a public communication component as described with reference to FIG. 2.

At step 920, a system may convey a subsequent message of the conversation according to the private mode, wherein the private mode comprises a default mode for each message of the conversation. In some cases, the operations of this step may refer to, or be performed by, a private communication component as described with reference to FIG. 2.

At step 925, a system may prompt the controlling user to select between the private mode and the public mode for the subsequent message. In some cases, the operations of this step may refer to, or be performed by, a mode selection component as described with reference to FIG. 2.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.”

What is claimed is:

1. A method for digital communication, comprising:
conveying a first message of a conversation from a bidding user to a controlling user, wherein the first message is sent according to a private mode of communication;
prompting the controlling user to select between the private mode and a public mode after conveying the first message;
receiving an indication from the controlling user to select a public mode based on the prompting; and
conveying the conversation, including the first message, to a plurality of additional bidding users based on the indication from the controlling user.

2. The method of claim 1, further comprising:
conveying a second message of the conversation from the controlling user to the bidding user and the plurality of additional bidding users based on the indication that the controlling user has selected the public mode.

3. The method of claim 1, further comprising:
receiving an authorization from the bidding user that the controlling user is allowed to select the public mode, wherein prompting the controlling user is based on the authorization from the bidding user.

4. The method of claim 1, further comprising:
receiving a subsequent indication from the controlling user to select a private mode for a subsequent conversation; and
preventing the plurality of additional bidding users from accessing the subsequent conversation based on the subsequent indication.

5. The method of claim 1, further comprising:
conveying at least one subsequent message of the conversation to the plurality of additional bidding users based on the indication from the controlling user.

6. The method of claim 1, further comprising:
setting the public mode as a default mode based on the indication; and
conveying at least one subsequent message of the conversation to the plurality of additional bidding users based on the public mode.

7. The method of claim 6, further comprising:
receiving a request from the controlling user to merge the additional message into the conversation; and
merging the at least one additional message into the conversation based on the request.

8. The method of claim 1, wherein:
the bidding user and the plurality of additional bidding users represent financial institutions, and the first message comprises a question related to financial information available to the controlling user.

9. The method of claim 1, wherein:
the first message is conveyed to the controlling user by posting the first message to a private inbox of the controlling user.

10. The method of claim 1, wherein:
the conversation is conveyed to the plurality of additional users by automatically posting the conversation to a public message board in response to receiving the indication from the controlling user.

11. The method of claim 1, further comprising:
notifying the bidding user that the controlling user may select the public mode prior to conveying the first message to the controlling user.

12. The method of claim 1, further comprising:
receiving a subsequent indication from the controlling user to select a private mode; and
restricting access to the conversation for the plurality of additional bidding users based on the subsequent indication.

13. The method of claim 1, further comprising:
receiving one or more edits from the controlling user; and
modifying the conversation based on the one or more edits, wherein conveying the conversation to the plurality of additional bidding users comprises conveying the modified conversation.

14. The method of claim 1, further comprising:
conveying a subsequent message of the conversation according to the private mode, wherein the private mode comprises a default mode for each message of the conversation; and
prompting the controlling user to select between the private mode and the public mode for the subsequent message.

15. A system for digital communication, comprising: a processor and a memory storing instructions and in electronic communication with the processor, the processor being configured to execute the instructions to:
convey a first message of a conversation from a bidding user to a controlling user, wherein the first message is sent according to a private mode of communication;
prompt the controlling user to select between the private mode and a public mode after conveying the first message;
receive an indication from the controlling user to select a public mode based on the prompting; and
convey the conversation, including the first message, to a plurality of additional bidding users based on the indication from the controlling user.

16. The system of claim 15, the processor being further configured to execute the instructions to:
receive an authorization from the bidding user that the controlling user is allowed to select the public mode, wherein prompting the controlling user is based on the authorization from the bidding user.

17. The system of claim 15, the processor being further configured to execute the instructions to:
receive a subsequent indication from the controlling user to select a private mode for a subsequent conversation; and
prevent the plurality of additional bidding users from accessing the subsequent conversation based on the subsequent indication.

18. A non-transitory computer readable medium storing code for digital communication, the code comprising instructions executable by a processor to:
convey a first message of a conversation from a bidding user to a controlling user, wherein the first message is sent according to a private mode of communication;
prompt the controlling user to select between the private mode and a public mode after conveying the first message;
receive an indication from the controlling user to select a public mode based on the prompting; and
convey the conversation, including the first message, to a plurality of additional bidding users based on the indication from the controlling user.

19. The non-transitory computer-readable medium of claim 18, the code further comprising instructions executable by the processor to:
convey a second message of the conversation from the controlling user to the bidding user and the plurality of additional bidding users based on the indication that the controlling user has selected the public mode.

20. The non-transitory computer-readable medium of claim 18, the code further comprising instructions executable by the processor to:
set the public mode as a default mode based on the indication; and
convey at least one subsequent message of the conversation to the plurality of additional bidding users based on the public mode.
